(19) United States
(12) Patent Application Publication
(10) Pub. No.: US 2024/0051480 A1
(43) Pub. Date: Feb. 15, 2024

(54) CONTROL DEVICE AND VOLTAGE SUPPLY METHOD FOR A CONTROL DEVICE

(71) Applicant: Robert Bosch GmbH, Stuttgart (DE)

(72) Inventors: Philipp Brechel, Stuttgart (DE); Adrian Haug, Leonberg (DE); Christoph Senneka, Speyer (DE); Dieter Bruss, Aidlingen (DE); Martin Karle, Leinfelden-Echterdingen (DE); Robert Schumann, Stuttgart (DE); Silke Bruening, Schwieberdingen (DE); Thomas Kroker, Aidlingen-Deufringen (DE); Wei Ling, Renningen (DE)

(21) Appl. No.: 18/261,054

(22) PCT Filed: Feb. 16, 2022
(86) PCT No.: PCT/EP2022/053755

§ 371 Date: Jul. 11, 2023

(30) Foreign Application Priority Data
Mar. 19, 2021 (DE) 10 2021 202 691.5

(51) Int. Cl. B60R 16/03

(52) U.S. Cl. CPC B60R 16/03

(57) ABSTRACT

A control device for a motor vehicle. In the event of an interruption of an external voltage supply, limited functionality can continue to be maintained. For this purpose, it is provided to deactivate some functional modules of the control device in the event of an interruption of the external supply voltage and to use electrical energy stored in the deactivated functional modules for the voltage supply of further functional modules.

### FIELD

The present invention relates to a control device, in particular to a control device for a motor vehicle. The present invention furthermore relates to a voltage supply method for such a control device.

### BACKGROUND INFORMATION

Modern motor vehicles generally have an increasing number of control units. In this context, central control units are also increasingly used, which combine several functions in a common control unit. Such central control units generally have a higher energy demand than a single individual control unit. In the event of an interruption of the supply voltage of control units, sufficiently large-dimensioned energy stores can be kept available in the control units in order to be able to ensure at least safety-relevant functions of the control unit for the duration of the interruption.

German Patent Application No. DE 10 2015 226 600 A1 describes a control unit for a vehicle, which is supplied via an external power supply. In this case, at least one partial functionality of the control unit is configured such that two voltage sources are available for this partial functionality.

### SUMMARY

The present invention provides a control device for a motor vehicle and a voltage supply method for a control device. Advantageous embodiments of the present invention are disclosed herein.

Accordingly, the following is provided according to an example embodiment of the present invention:

A control device for a motor vehicle with a voltage supply module. The voltage supply module is configured to be connected to an electrical voltage source at an input terminal. Furthermore, the voltage supply module is configured to provide an electrical supply voltage for several functional modules of the control device. The voltage supply module is furthermore configured to provide an intermediate voltage in the event of an interruption of an input voltage at the input terminal of the voltage supply module. In this case, the voltage module is furthermore configured to provide the provided intermediate voltage during the interruption of the input voltage only at a predetermined subset of the plurality of functional modules.

The following is furthermore provided according to an example embodiment of the present invention:

A power supply method for a control device, in particular for a control device of a motor vehicle. The power supply method comprises a step of providing supply voltages to functional modules of the control device. The supply voltages are in particular provided by using an input voltage provided at the control device. Furthermore, the method comprises a step of detecting an interruption of the input voltage provided at the control device. Moreover, the method comprises a step of generating an intermediate voltage at a subset of the functional modules. The intermediate voltage is in particular generated by using electrical energy stored in the control device. This intermediate voltage is provided at the subset of the functional modules if an interruption of the input voltage provided at the control device has been detected.

The present invention is based on the knowledge that temporary interruptions can occur with a supply voltage for a control device, such as a control unit of a motor vehicle. For example, when a powerful consumer is connected to an energy supply network to which such a control device is connected, a brief significant voltage drop may occur so that the electrical energy provided by such an energy supply network is no longer sufficient in the short term for a reliable energy supply of the functional modules in such a control device. In order to continue to ensure reliable operation of the functional modules within the control device during such voltage interruptions, correspondingly large-dimensioned energy stores, such as capacitors or the like, can be provided in the control device. With increasing energy demand of the functional modules of a control device, correspondingly large-dimensioned energy stores must therefore also be provided. However, such energy stores, such as capacitors, require a relatively large installation space and are generally also associated with high costs.

It is therefore one feature of the present invention to take this knowledge into account and to provide a concept for a voltage supply in a control device, which enables safe and reliable operation of the control device in the event of temporary drops in the energy supply. For this purpose, it is provided to supply a temporary intermediate voltage to a portion of the functional modules provided in the control device, in the event of a disruption, in particular of an interruption, of the supply voltage for the control device.

In this context, the term “intermediate voltage” refers to an electrical voltage for the energy supply of components in the control device that is provided to maintain the function of the corresponding components of the control device at least in part or to a limited extent during a temporary disruption or interruption of the external energy supply. Where applicable, it is also possible to provide an intermediate voltage that provides only a portion of the energy demand for the corresponding components of the control device. In this case, a further energy buffer can be provided, and the energy demand of the respective component can for stable operation during an interruption of the supply voltage for a specified period of times can be covered concertedly by means of the provided intermediate voltage and the electrical energy from the further energy buffer. By providing the intermediate voltage, the energy buffer can be dimensioned smaller than in a concept in which the energy supply of the components must be covered exclusively by the energy buffer.

In this context, the term “functional module” is understood to mean modules or components of a control unit. For example, functional modules may receive and/or evaluate sensor signals, drive actuators, enable communication with further, in particular external, components, or perform any other specified processes in a control device.

Further components, such as the remaining functional modules, can be temporarily limited or deactivated in this case. As a result, it is possible to use electrical energy from energy stores in the temporarily deactivated components to generate the intermediate voltage that supplies electrical energy to the functional modules while the external energy supply is interrupted. This makes it possible to maintain at least a portion of the functionality of the control device even in the event of an interruption of the energy supply. For example, prioritized functionalities, such as safety-relevant functions, can be maintained even in the event of an interruption of the external energy supply, while functionalities of a lower priority are deactivated in the event of an interruption of the external energy supply.

Such a feature for the partial energy supply within a control device makes it possible to temporarily maintain particularly relevant functionalities even if an external energy supply is interrupted in the short term. By restricting the functionalities during the interruption of the energy supply to predetermined partial functionalities, the internal energy consumption within the control device can be reduced. As a result, the electrical energy stores that provide the electrical energy during the interruption of the external energy supply can be dimensioned smaller. As explained in more detail below, electrical energy stores, such as capacitors or the like, from functional groups that are deactivated during the interruption of the external energy supply may, for example, also be discharged, in particular in order to provide the electrical energy during the interruption of the external energy supply. Such electrical energy stores may, for example, be capacitors that stabilize a DC voltage supply of the respective functional groups in normal operation. Thus, such capacitors perform two different tasks: on the one hand, they serve to stabilize the voltage supply in the normal operating mode, and on the other hand, they serve as electrical energy stores for providing electrical energy if an external energy supply is interrupted. Since such capacitors for stabilizing the voltage supply are generally provided anyway, additional energy stores can therefore be omitted or at least be dimensioned correspondingly smaller.

According to one example embodiment of the present invention, the voltage supply module of the control device is configured to draw electrical energy for providing the intermediate voltage from one or more electrical energy stores of the control device. In principle, the electrical energy may be provided by any electrical energy store but in particular by a capacitor or the like. In addition to a central electrical energy store, for example a capacitor in the voltage supply module, it is possible to use several smaller energy stores. The smaller electrical energy stores may, for example, also be provided distributed in the individual functional modules of the control device.

According to one example embodiment of the present invention, the voltage supply module is configured to draw electrical energy for providing the intermediate voltage from one or more capacitors of functional modules. In particular, the electrical energy can be drawn from capacitors of functional modules that are not supplied with the intermediate voltage during the interruption of the input voltage at the input terminal, i.e., functional modules that are deactivated in the event of an interruption of the input voltage. As already mentioned above, as long as an external input voltage is provided, such capacitors may be used in normal operation to stabilize the respective supply voltage for the functional modules. In the event of an interruption of the input voltage, these capacitors can then be purposefully discharged and the electrical energy stored in the respective capacitors can be used to provide the intermediate voltage during the interruption of the input voltage.

According to one example embodiment of the present invention, the control device comprises a DC-to-DC converter. The DC-to-DC converter may be arranged between the voltage supply module and a functional module. In particular, the DC-to-DC converter may be arranged between the voltage supply module and a functional module that is not supplied with the intermediate voltage in the event of an interruption of the external input voltage. In this case, the DC-to-DC converter may be configured to provide electrical energy from an electrical energy store of the functional module connected to the DC-to-DC converter, at the voltage supply module in the event of an interruption of the external input voltage. In particular, the DC-to-DC converter may in this case control the electrical voltage provided at the voltage supply module, in such a way that an at least approximately constant electrical DC voltage is provided at the voltage supply module. In this way, at the DC voltage supply module, a constant DC voltage can be provided at the voltage supply module even in the event of a decreasing electrical voltage during the discharge process of the electrical energy stores in the corresponding functional module.

Alternatively, according to an example embodiment of the present invention, it is also possible for a functional module to be connected to the external energy supply via a DC-to-DC converter, wherein the DC-to-DC converter converts the DC voltage provided by the external energy supply into a further DC voltage, the voltage level of which is higher than the voltage level of the external energy supply. In this case, an electrical energy store of such a functional module can be discharged in the event of an interruption of the external input voltage, wherein the voltage level of the electrical energy store will continuously decrease during the discharge process. An additional DC-to-DC converter may possibly be provided for discharging the electrical energy store.

Electrical energy stores of the functional modules, in particular of functional modules with a raised DC voltage, may possibly be discharged to a lower voltage level, with which the respective functional module can still continue to be operated, at least to a limited extent.

According to one example embodiment of the present invention, the DC-to-DC converter between the voltage supply module and the functional module may be designed as a bidirectional DC-to-DC converter. On the one hand, such a DC-to-DC converter can provide an electrical DC voltage at a specified voltage level from the voltage supply module to the respective functional module in normal operation, i.e., while an external input voltage is provided at the control device. Moreover, in the event of an interruption of the external input voltage, the same DC-to-DC converter may also transmit electrical energy from the functional module, in particular from electrical energy stores, such as capacitors in the functional module, to the voltage supply module. Such DC-to-DC converters are, for example, also known under the term “two-quadrant actuator.” According to one example embodiment of the present invention, in the event of an interruption of the input voltage at the input terminal of the voltage supply module, electrical energy can be transmitted to the voltage supply module via an internal diode, in particular an internal body diode of the DC-to-DC converter. In this way, an electrical energy store in the respective functional module can also be discharged particularly simply and without further circuit complexity if the external input voltage of the control device is interrupted.

According to one example embodiment of the present invention, the control device comprises at least one functional module comprising a monitoring module. The monitoring module of the corresponding functional module may be configured to monitor further functional modules of the control device. Additionally or alternatively, the monitoring module may provide a communication link to an external component. In this case, the voltage supply module may be configured to provide the intermediate voltage at least at the monitoring module in the event of an interruption of the input voltage at the input terminal. In this way, the corresponding functionalities of the functional module with the monitoring module can continue to be maintained even in the event of an interruption of the external input voltage. If, for example, external communication is realized by means of the corresponding functional module, disruption of the external communication can be avoided by maintaining the respective function. It can thus be ensured that in the event of an interruption of the input voltage at the control device, the external communication is not disrupted and functionalities of further external components involved in this communication are thus also not impaired.

Furthermore, it can also in particular be ensured by maintaining internal monitoring that in the event of an interruption of the external voltage supply of the control device, the internal functionalities are transferred to a safe state and uncontrolled impairments or disruptions are thus avoided. For example, in the event of an interruption of the external energy supply, the monitoring module can put at least a portion of the further functional modules of the control device into a standby mode in a controlled manner and can in this way further reduce the internal energy demand.

According to one example embodiment of the present invention, the control device may comprise several functional modules designed as a system-on-chip. In particular, several different functional modules may also be implemented as a common system-on-chip.

According to one example embodiment of the present invention, the power consumption of one or more predetermined functional modules can be reduced if an interruption of the input voltage provided at the control device has been detected. For example, the power consumption of the corresponding functional modules may be reduced by completely deactivating the functional modules. Alternatively, it is also possible to put at least a portion of the functional modules into a standby mode and to reduce the energy demand in this way. In particular, it is also possible to first shut down a functional module in a controlled manner in a multi-stage approach and to, for example, store a current system state in the process. In a further step, the corresponding functional module can then be completely deactivated. In this way, at a later time, when the external energy supply is again available, the corresponding functional module can be purposefully restarted and initialized. Of course, any other approaches for reducing the power consumption and/or deactivating functional modules are also possible.

The described embodiments and developments of the present invention may be combined with one another as desired, where appropriate. Further embodiments, developments, and implementations of the present invention also include not explicitly specified combinations of features of the present invention described above or below with respect to the exemplary embodiments. The person skilled in the art will in particular also add individual aspects as improvements or additions to the respective basic forms of the present invention.

### BRIEF DESCRIPTION OF THE DRAWINGS

Further features and advantages of the present invention are explained hereinafter with reference to the figures.

FIG. 1 shows a schematic representation of a block diagram of a control device according to one example embodiment of the present invention.

FIG. 2 shows a schematic representation of a block diagram of a control device according to a further embodiment of the present invention.

FIG. 3 shows a flow chart as underlying a voltage supply method for adjusting calibration parameters, according to one embodiment of the present invention.

### DETAILED DESCRIPTION OF EXAMPLE EMBODIMENTS

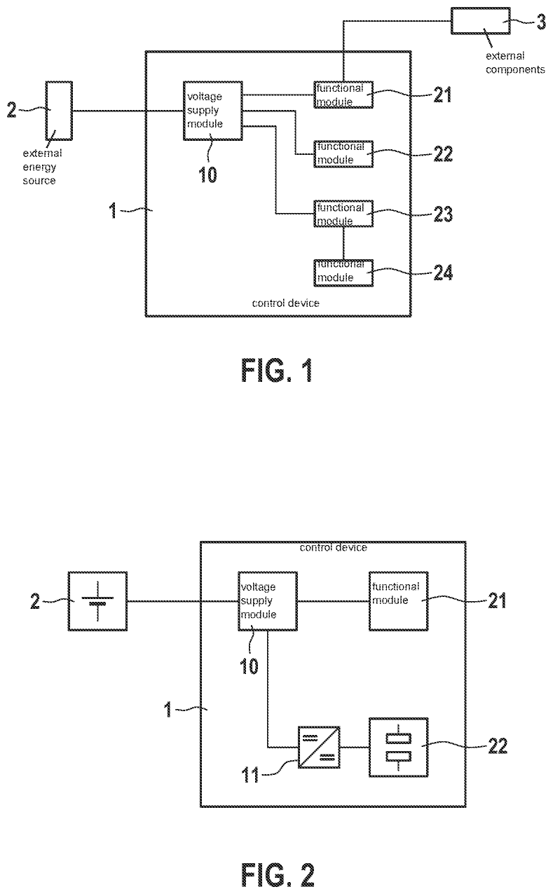

FIG. 1 shows a schematic representation of a block diagram of a control device 1 according to one embodiment. The control device 1 may, for example, be supplied with electrical energy by an external energy source 2, in particular an external DC voltage source. For example, this may be an onboard DC voltage network of a motor vehicle. For example, the electrical voltage provided by the DC voltage source may supply electrical energy to one or more functional modules 21 to 24 via a voltage supply module 10.

If the individual functional modules 21 to 24 require a different electrical voltage, in particular an electrical voltage that deviates from the input voltage, the electrical voltage can be adjusted correspondingly by means of one or more DC-to-DC converters or voltage regulators. In this way, a suitable electrical supply voltage can be provided to each functional module 21 to 24.

For this purpose, the individual functional modules 21 to 24 may be connected directly to the voltage supply module 10. Alternatively, individual functional modules 24 may also be supplied with electrical energy via other functional modules 23, for example.

The individual functional modules 21 to 24 may realize any different functions. For example, a functional module 21 that provides a communication link to one or more external components 3 may be provided. For this purpose, the corresponding functional module 21 may, for example, be connected to other components via a data connection, such as a communication bus, e.g., a CAN bus or a network connection.

Moreover, individual functional modules 22 to 24 may also be assigned to any suitable sensors or actuators. For example, the functional modules 22 to 24 may include camera modules for capturing image data, ultrasonic sensors for distance measurement to an external obstacle, or any other suitable sensors, in particular surroundings sensors. Actuators, such as servomotors or the like, are likewise possible, for example.

Depending on the functionality of the individual functional modules 21 to 24, different priorities may be assigned to the individual functional modules 21 to 24. For example, functional modules for safety-relevant functionalities may be assigned higher priorities. Other functional modules 21 to 24 may, for example, be assigned a lower priority at which a temporary interruption of the respective functionality may possibly also be accepted.

For example, an impairment of a functional module 21 for communication with further external components could lead to a disruption of the entire communication sequence and possibly also to the transmission of incorrect information. In such a case, a corresponding communication module 21 can therefore be assigned a higher priority. If, for example, camera modules that only provide optical information for visualization on a display screen are moreover also provided among the functional modules 22 to 24, a brief interruption of these image signals may possibly be accepted so that such functional modules 22 to 24 can be assigned a correspondingly lower priority.

If an interruption of the external supply voltage from the voltage source 2 now occurs during the operation of the control device 1, the goal of the control device 1 is to preferably maintain the function of functional modules 21 to 24 of a higher priority. In contrast, a temporary impairment of functional modules 22 to 24 of a lower priority may possibly be temporarily accepted.

In the event of a temporary interruption of the external voltage supply, the voltage supply module 10 can therefore continue to supply a supply voltage, hereinafter intermediate voltage, to a specified group of functional modules 21 to 24. Other functional modules 22 to 24, such as the functional modules 22 to 24 designated above as functional modules of a lower priority, may be deactivated for the time period in which the external voltage supply is interrupted.

During the time period in which the external voltage supply 2 is temporarily interrupted, it is necessary to draw from an internal energy store the electrical energy for supplying the selected functional modules 21 to 24 with the intermediate voltage. For example, a suitable electrical energy store, such as a correspondingly large-dimensioned capacitor, can in principle be provided in the voltage supply module 10 for this purpose.

Moreover, it is also possible to use electrical energy stored in electrical energy stores of the functional modules that can be deactivated during the interruption of the external energy supply, for generating the intermediate voltage. For example, capacitors may be provided in the voltage supply lines to the individual functional modules 21 to 24, which capacitors stabilize the respective supply voltage of the corresponding functional modules 21 to 24 in normal operation, i.e., in operation when the voltage supply is provided by the external energy source 2. A certain amount of electrical energy is thus initially stored in these capacitors.

For example, the electrical energy in the capacitors provided in functional modules 22 to 24 that can be deactivated in the event of an interruption of the external voltage supply 2 can be used for generating the intermediate voltage. In other words, the voltage supply module 10 can discharge electrical energy stores, such as capacitors, in those functional modules 22 to 24 that can be deactivated in the event of an interruption of the external voltage supply 2. This energy can be used to generate the intermediate voltage.

Since the voltage level of the capacitors will generally decrease during the discharge process, a DC-to-DC converter may be provided in the voltage supply module 10, which DC-to-DC converter in each case raises the electrical voltage provided by the energy stores in the deactivated functional modules 22 to 24, to a voltage level of the desired intermediate voltage.

FIG. 2 shows a schematic representation of a block diagram of a control device 1 according to a further embodiment. The embodiment shown in FIG. 2 corresponds as far as possible to the above-described embodiment according to FIG. 1. The embodiment shown in FIG. 2 differs from the above-described embodiment in particular in that a DC-to-DC converter 11 may be provided between the voltage supply module 10 and one or more functional modules 22. In a normal operation in which the electrical energy is supplied by the external voltage source 2, this DC-to-DC converter 11 can raise or lower the voltage level provided by the external voltage source 2, to a voltage level required for the operation of the respective functional module 22.

In the event of a temporary interruption of the external voltage supply 2, electrical energy can then be drawn from an electrical energy store, for example a capacitor in the functional module 22, and provided to the voltage supply module 10 via the respective DC-to-DC converter 11 in order to provide the required intermediate voltage.

In one embodiment, the electrical energy can flow from the energy store in the functional module 22 via an internal diode, e.g., via a body diode in the DC-to-DC converter 11, in the direction of the voltage supply module 10.

Alternatively, it is also possible for the corresponding DC-to-DC converter 11 to be designed as a bidirectional DC-to-DC converter, which can transmit electrical energy not only from the voltage supply module 10 in the direction of the functional module 22 but also in the reverse direction from the functional module 22 in the direction of the voltage supply module 10. In this case, the DC-to-DC converter 11 can in each case be controlled in such a way that, when energy flows from the functional module 22 in the direction of the voltage supply module 10, the electrical voltage provided at the voltage supply module 10 is preferably at least approximately constant.

By the above-described provision of an intermediate voltage during the temporary interruption of the external voltage supply 2, it is possible to continue to operate at least a portion of the functional modules 21 to 24. In this way, safety-relevant functionalities can, for example, be maintained even in the event of a short-term interruption of the external voltage supply 2. For example, interruptions in a time period of up to 20 milliseconds (ms) or possibly up to 100 ms can be considered as a temporary interruption of the external voltage supply. Moreover, depending on the dimensioning of the electrical energy store within the control device 1, in particular the dimensioning of the corresponding capacitors, other time periods for a temporary interruption of the external voltage supply 2 are however also possible.

Moreover, it is also possible to limit the functionality of some functional modules 21 to 24 while the external voltage supply 2 is interrupted. In this way, the energy demand for operating the corresponding functional modules 21 to 24 can be reduced. In particular, it is possible, for example, to operate the functional modules 21 to 24 with a reduced energy demand as long as the corresponding functional modules are supplied with the intermediate voltage provided by the voltage supply module 10.

Furthermore, in the event of an interruption of the external voltage supply 2, a multi-stage approach is, where applicable, also possible, in which, for example, in a first phase, the functional modules 22 to 24 to be deactivated are first put into a safe state, e.g., into a standby mode, in a controlled manner and, in a further phase, the functional modules are subsequently completely deactivated. In this way, uncontrolled operating states or signal flows may possibly be avoided.

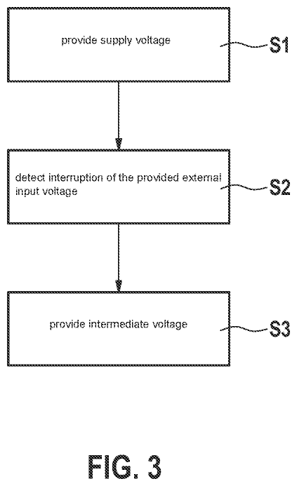

FIG. 3 shows a flow chart as underlying a voltage supply method for a control device 1 according to one embodiment. In step S1, a supply voltage is first provided at several functional modules 21-24 of the control device 1. The supply voltage is in this case provided by using an input voltage provided externally.

In step S2, an interruption of the provided external input voltage is detected. An intermediate voltage is then provided in step S3. This intermediate voltage is in particular only provided to a subset of the functional modules 21-24 of the control device 1. The intermediate voltage is in this case provided by using electrical energy stored in the control device 1. The intermediate voltage is provided after an interruption of the external input voltage has been detected.

Furthermore, the method may, for example, comprise a step of reducing the power consumptions of one or more predetermined functional modules 21-24. The power consumption can in particular be reduced if an interruption of the input voltage provided at the control device 1 has been detected.

In summary, the present invention relates to a control device, in particular to a control device for a motor vehicle, wherein in the event of an interruption of an external voltage supply, limited functionality can continue to be maintained. For this purpose, it is provided to deactivate some functional modules of the control device in the event of an interruption of the external supply voltage and to use electrical energy stored in the deactivated functional modules for the voltage supply of further functional modules.

1-10. (canceled)

11. A control device for a motor vehicle, comprising:
a voltage supply module configured to be connected to an electrical voltage source at an input terminal and to provide an electrical supply voltage for several functional modules of the control device;
wherein the voltage supply module is configured to generate, in the event of an interruption of an input voltage at the input terminal, an intermediate voltage for an energy supply of a predetermined subset of the several functional modules and to provide the generated intermediate voltage at the predetermined subset of the plurality of functional modules.

12. The control device according to claim 11, wherein the voltage supply module is configured to draw electrical energy for providing the intermediate voltage from one or more electrical energy stores of the control device.

13. The control device according to claim 11, wherein the voltage supply module is configured to draw electrical energy for generating the intermediate voltage from one or more capacitors of functional modules that are not supplied with the intermediate voltage in the event of an interruption of the input voltage at the input terminal.

14. The control device according to claim 11, further comprising a DC-to-DC converter arranged between the voltage supply module and at least one of the functional modules and configured to transmit electrical energy from the at least one of functional modules to the voltage supply module in the event of an interruption of the input voltage at the input terminal of the voltage supply module.

15. The control device according to claim 14, wherein the DC-to-DC converter includes a bidirectional DC-to-DC converter.

16. The control device according to claim 14, wherein, during the interruption of the input voltage at the input terminal of the voltage supply module, electrical energy is transmitted to the voltage supply module via an internal body diode of the DC-to-DC converter.

17. The control device according to claim 11, wherein at least one of the functional modules is a monitoring module, wherein the monitoring module is configured to monitor further ones of the functional modules of the control device and/or to provide a communication link to an external component, wherein the voltage supply module is configured to provide the intermediate voltage at least at the monitoring module during the interruption of the input voltage at the input terminal.

18. The control device according to claim 11, wherein the control device includes the several functional modules as is a system-on-chip.

19. A voltage supply method for a control device, the method comprising the following steps:
providing supply voltages to functional modules of the control device by using an input voltage provided at the control device;
detecting an interruption of the input voltage provided at the control device; and
providing an intermediate voltage at a subset of the functional modules by using electrical energy stored in the control device when an interruption of the input voltage provided at the control device has been detected.

20. The voltage supply method according to claim 19, further comprising:
reducing a power consumption of one or more predetermined functional modules when an interruption of the input voltage provided at the control device has been detected.
